(19) United States
(12) Patent Application Publication
(10) Pub. No.: US 2010/0093389 A1
(43) Pub. Date: Apr. 15, 2010

(54) RESPONDING TO A PAGING REQUEST FROM A GSM NETWORK BY SETTING UP THE CALL THROUGH A UMTS NETWORK

(75) Inventors: Ramanathan Asokan, Cary, NC (US); Phillip Clifford Kidd, Fuquay Varina, NC (US); Toby John Bowen, Durham, NC (US)

Correspondence Address: MYERS BIGEL SIBLEY & SAJOVEC, P.A., P.O. BOX 37428, RALEIGH, NC, 27627, US

(73) Assignee: Sony Ericsson Mobile Communications AB

(21) Appl. No.: 12/250,834

(22) Filed: Oct. 14, 2008

(51) Int. Cl. H04M 1/00

(52) U.S. Cl. 455/552.1

(57) ABSTRACT

A mobile terminal includes a GSM transceiver, a UMTS transceiver, and a controller. The GSM transceiver communicates via a GSM radio communication interface. The UMTS transceiver communicates via a UMTS radio communication interface. The controller is configured to select and register with a UMTS cell provided by a UMTS radio network controller, to store UMTS cell data defining a snapshot of communication characteristics of the selected UMTS cell, to respond to having registered with the selected UMTS cell by monitoring a GSM control channel via the GSM transceiver for an incoming paging request transmitted by a GSM base station controller, and to respond to receipt of the paging request from the GSM base station controller by using the stored UMTS cell data to assist in setting up a corresponding call via the UMTS transceiver and the selected UMTS cell through the UMTS radio network controller and a UMTS core network.

### FIELD OF THE INVENTION

This invention relates to wireless communication terminals, and more particularly to multi-mode wireless terminals that can communicate over more than one radio access technology communication interface.

### BACKGROUND

Multi-mode wireless terminals have been developed that can communicate with Global System for Mobile Communications (GSM) systems and third generation Universal Mobile Telephone Service (UMTS) systems. In some geographic areas, both of these wireless communication systems may be available for use by wireless terminals.

One concern in the development of UMTS systems was the definition of processes which permit inter-system cell reselection and handover from GSM to UMTS, and visa-verse. During the initial deployment of UMTS systems, it is important that UMTS systems interoperate with existing GSM systems, since, for example, for a given effective radiated power level, a GSM transmission at 900 MHz can exhibit better ability to penetrate most modern building materials, when compared to a UMTS transmission at 2100 MHz. For this and other reasons, such as to obtain traffic load balancing, handovers between GSM and UMTS can be desirable.

In order to prepare for a handover from GSM to UMTS, the mobile station must acquire synchronization on the UMTS target cell prior to the handover while simultaneously involved in dedicated traffic flow for an ongoing call on a GSM traffic channel (TCH). However, operations associated with acquiring synchronization to a UMTS cell can be unacceptably long and exceed the amount of time normally available (i.e. schedulable) during a GSM circuit-switched voice call, causing the handover to be problematic.

For example, in order to acquire synchronization on UMTS, a typical period of 10 to 12 free GSM idle frames may be required under ideal conditions. Assuming that all idle frames are free, then the actual period required may be 1.44 seconds. However, the time that is required for synchronization to UMTS is heavily influenced by a variable quantity expressed as the ratio of the energy per chip to base channel interference level, and may range from 1.44 seconds, under ideal conditions, to between 5 and 16 seconds, in the case of fast-moving mobile stations and poor energy per chip to base channel interference levels. This dependency is further complicated by the fact that a GSM idle frame must actually be free, and therefore available for use by the UMTS synchronization procedure. The actual time required in a real GSM/UMTS operational environment may therefore be in a range of from about 1.44 seconds to about 16 seconds.

Consequently, handover of an on-going call/data transfer from GSM to UMTS may interrupt the call/data transfer for up to 16 seconds, which may be unacceptable for some applications.

### SUMMARY

In some embodiments of the present invention, a mobile terminal includes a GSM transceiver, a UMTS transceiver, and a controller. The GSM transceiver is configured to communicate via a GSM radio communication interface. The UMTS transceiver is configured to communicate via a UMTS radio communication interface. The controller is configured to select and register with a UMTS cell provided by a UMTS radio network controller, to store UMTS cell data defining a snapshot of communication characteristics of the selected UMTS cell, to respond to having registered with the selected UMTS cell by monitoring a GSM control channel via the GSM transceiver for an incoming paging request transmitted by a GSM base station controller, and to respond to receipt of the paging request from the GSM base station controller by using the stored UMTS cell data to assist in setting up a corresponding call via the UMTS transceiver and the selected UMTS cell through the UMTS radio network controller and a UMTS core network.

In some further embodiments, the controller may be further configured to respond to completing registration with the selected UMTS cell by selecting and registering with a GSM cell provided by a GSM base station controller, and monitoring the GSM control channel of the GSM base station controller for the paging request.

The controller may be further configured to respond to a signal indicating that a battery power source of the mobile terminal has less than a threshold remaining power reserve by at least temporarily ceasing monitoring of a control channel of the selected UMTS cell for a paging request transmitted by the UMTS radio network controller and by initiating monitoring of the GSM control channel via the GSM transceiver for the paging request transmitted by the GSM base station controller.

The controller may be further configured to include frequency data for a control channel of the selected UMTS cell as at least part of the stored UMTS cell data, and to respond to receipt of the paging request from the GSM base station controller by controlling the UMTS transceiver to transmit a call setup message at the control channel frequency that is defined by the stored frequency data.

The controller may be further configured to obtain and include synchronization data for a control channel of the selected UMTS cell as part of the stored UMTS cell data, and to respond to receipt of the paging request from the GSM base station controller by controlling the UMTS transceiver to synchronize its transmission of the call setup message to the control channel of the selected UMTS cell using the stored synchronization data.

The controller may be further configured to obtain and include data that identifies a scrambling code for a communication channel of the selected UMTS cell as at least part of the stored UMTS cell data, and to respond to receipt of the paging request from the GSM base station controller by transmitting a call setup message through the control channel of the selected UMTS cell using the stored scrambling code data to scramble the paging request when transmitted.

The controller may be further configured to receive via the UMTS transceiver a temporary identification code that has been assigned by the UMTS core network to the mobile terminal, to include the temporary identification code as at least part of the stored UMTS cell data, and to respond to receipt of the paging request from the GSM base station controller by transmitting a call setup message, which includes the stored temporary identification code for the mobile terminal, to the UMTS radio network controller.

The controller may be further configured to power-down at least a portion of the UMTS transceiver in response to completing registration with the selected UMTS cell, and to power-on the previously powered-down portion of the UMTS transceiver in response to receiving the paging request from the GSM base station controller.

The controller may be further configured to respond to expiration of a threshold time after completing registration with the selected UMTS cell during which no paging request was received from the GSM base station controller by obtaining and storing updated UMTS cell data.

The controller may be further configured to respond to expiration of the threshold time after completing registration with the selected UMTS cell during which no paging request was received from the GSM base station controller by obtaining and including updated synchronization data for the control channel of the selected UMTS cell as part of its storage of updated UMTS cell data.

The controller may be further configured to observing at least a threshold change in timing synchronization between the GSM transceiver and the GSM base station controller by obtaining and storing updated UMTS cell data.

The controller may be further configured to respond to observing at least a threshold change in timing synchronization between the GSM transceiver and the GSM base station controller by obtaining and including updated synchronization data for the control channel of the selected UMTS cell as part of its storage of updated UMTS cell data.

The controller may be further configured to respond to being handed-off from one GSM base station controller to another GSM base station controller, while waiting for a paging request from a GSM base station controller, by obtaining and storing updated UMTS cell data.

The controller may be further configured to respond to initiation of a GSM cell reselection process by obtaining and storing updated UMTS cell data.

The controller may be further configured to respond to sensing a user triggered activity signal by obtaining and storing updated UMTS cell data. The controller may respond to sensing a portion of a housing for the mobile terminal being opening, sensing actuation of a pressure switch of the mobile terminal, sensing a user touching a touch sensitive display of the mobile terminal, and/or sensing movement of the mobile terminal by obtaining and storing updated UMTS cell data in preparation for the user initiating a call.

The controller may be further configured to respond to sensing a portion of a housing for the mobile terminal being opening, sensing actuation of a pressure switch of the mobile terminal, sensing a user touching a touch sensitive display of the mobile terminal, and/or sensing movement of the mobile terminal by using the stored UMTS cell data to assist in monitoring a UMTS control channel of the selected UMTS cell in preparation for the user initiating a call.

The controller may be further configured to respond to completing registration with the selected UMTS cell by notifying the UMTS core network via the UMTS transceiver that it will monitor a GSM control channel for a paging request from a GSM base station controller.

Some other embodiments of the present invention are directed to a method that includes receiving notification at a core network through a UMTS radio network controller from a mobile terminal that indicates that the mobile terminal will monitor a GSM control channel from a GSM base station controller for any paging request. The notification is responded to by forwarding a paging request, which is received by the core network and is directed to the mobile terminal, to the GSM base station controller for communication to the mobile terminal. A paging response is received from the mobile terminal through the UMTS radio network controller, and a call is established with the mobile terminal, responsive to the paging response, through the core network and the UMTS radio network controller.

In yet some other embodiments of the present invention, a core network includes a UMTS mobile switching center that is configured to receive notification from a mobile terminal through a UMTS radio network controller that indicates that the mobile terminal will monitor a GSM control channel from a GSM base station controller for any paging request, and to respond to the notification by forwarding a paging request, which is directed to the mobile terminal, to the GSM base station controller for communication to the mobile terminal, and to respond to receipt of a paging response from the mobile terminal through the UMTS radio network controller by establishing a call with the mobile terminal through the UMTS radio network controller.

### BRIEF DESCRIPTION OF THE DRAWINGS

The accompanying drawings, which are included to provide a further understanding of the invention and are incorporated in and constitute a part of this application, illustrate certain embodiments of the invention. In the drawings:

FIG. 1 illustrates a wireless communication system that, according to various embodiments of the present invention, is configured so that a mobile communication terminal registers with a UMTS network and then monitors for and responds to a paging request from a GSM network by setting up the corresponding call through the UMTS network;

FIG. 2 illustrates an exemplary block diagram of circuitry of the wireless communication terminal shown in FIG. 3 in accordance with some embodiments of the present invention;

FIG. 3 illustrates a flowchart of operations that may be carried out by the wireless communication terminal shown in FIGS. 1 and 2 in accordance with some embodiments of the present invention; and

FIG. 4 illustrates a data flow diagram and flowchart of operations that may be carried out by the mobile communication terminal, by the GSM base station controller, by the UMTS radio network controller, and by the core network shown in FIGS. 1 and 2 in accordance with some embodiments of the present invention.

### DETAILED DESCRIPTION

Various embodiments of the present invention will now be described more fully hereinafter with reference to the accompanying drawings. However, this invention should not be construed as limited to the embodiments set forth herein. Rather, these embodiments are provided so that this disclosure will be thorough and complete, and will convey the scope of the invention to those skilled in the art.

It will be understood that, as used herein, the term “comprising” or “comprises” is open-ended, and includes one or more stated elements, steps and/or functions without precluding one or more unstated elements, steps and/or functions. As used herein, the singular forms “a”, “an” and “the” are intended to include the plural forms as well, unless the context clearly indicates otherwise. The term “and/or” and “/” includes any and all combinations of one or more of the associated listed items. In the drawings, the size and relative sizes of regions may be exaggerated for clarity. Like numbers refer to like elements throughout.

Some embodiments may be embodied in hardware and/or in software (including firmware, resident software, micro-code, etc.). Consequently, as used herein, the term “signal” may take the form of a continuous waveform and/or discrete value(s), such as digital value(s) in a memory or register. Accordingly, as used herein, the terms “circuit” and “controller” may take the form of digital circuitry, such as computer-readable program code (e.g., software applications) executed by an instruction processing device(s) (e.g., general purpose microprocessor and/or digital signal processor), and/or analog circuitry.

Embodiments are described below with reference to block diagrams and operational flow charts. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

It will be understood that a block of the block diagrams or flowcharts, and combinations of blocks in the block diagrams or flowcharts, may be implemented at least in part by computer program instructions. These computer program instructions may be provided to one or more enterprise, application, personal, pervasive and/or embedded computer systems, such that the instructions, which execute via the computer system(s) create means, modules, devices or methods for implementing the functions/acts specified in the block diagram block or blocks. A computer program according to embodiments of the invention comprises a computer usable storage medium having computer-readable program code embodied therein. Combinations of general purpose computer systems and/or special purpose hardware also may be used in other embodiments.

These computer program instructions may also be stored in memory of the computer system(s) that can direct the computer system(s) to function in a particular maimer, such that the instructions stored in the memory produce an article of manufacture including computer-readable program code which implements the functions/acts specified in block or blocks. The computer program instructions may also be loaded into the computer system(s) to cause a series of operational steps to be performed by the computer system(s) to produce a computer implemented process such that the instructions which execute on the processor provide steps for implementing the functions/acts specified in the block or blocks. Accordingly, a given block or blocks of the block diagrams and/or flowcharts provides support for methods, computer program products and/or systems (structural and/or means-plus-function).

Although various embodiments of the present invention are described in the context of mobile communication terminals for purposes of explanation of various embodiments, however it is to be understood that the present invention is not limited to such configurations, but is intended to encompass any configuration capable of carrying out at least one of the operational embodiments described herein. As used herein, a “mobile communication terminal”, “mobile terminal”, or “terminal” includes, but is not limited to, any electronic device that is configured to communicate via a GSM air interface protocol and via a UMTS air interface protocol, including predecessor and/or successor standards that define at least a portion of the GSM and UMTS standards. Examples of mobile terminals may include, but are not limited to, a cellular wireless terminal; a personal communication terminal that may combine a cellular wireless terminal with data processing, facsimile and/or data communications capabilities; a personal data assistance (PDA) that can include a wireless transceiver, pager, Internet/intranet access, local area network interface, wide area network interface, Web browser, organizer, and/or calendar; and/or a mobile or fixed computer or other device that includes a wireless transceiver.

Some embodiments of the present invention may arise from the present realization that when a mobile terminal is in an idle mode monitoring a UMTS control channel for an incoming paging request from a UMTS radio network controller, it may draw up to twice the average current that it uses when it is in an idle mode monitoring a GSM control channel for a page request from a GSM base station controller. In accordance with various embodiments of the present invention, a mobile terminal selects and registers with a UMTS cell provided by a UMTS radio network controller. The mobile terminal stores UMTS cell data that defines a snapshot of communication characteristics of the selected UMTS cell. The mobile terminal responds to completing registration with the selected UMTS cell by now monitoring a GSM control channel via the GSM transceiver for a paging request transmitted by a GSM base station controller. The mobile terminal responds to its receipt of the paging request by using the stored UMTS cell data to assist it in setting up a corresponding call via the UMTS transceiver and the selected UMTS cell through the UMTS radio network controller and a UMTS core network. Accordingly, by idling on a GSM control channel while waiting for a paging request and then setting up the call through the UMTS radio network controller, the mobile terminal may consume less power while idling waiting for a paging request and may still enable use of more advanced performance and features provided by the UMTS radio network controller during the corresponding call.

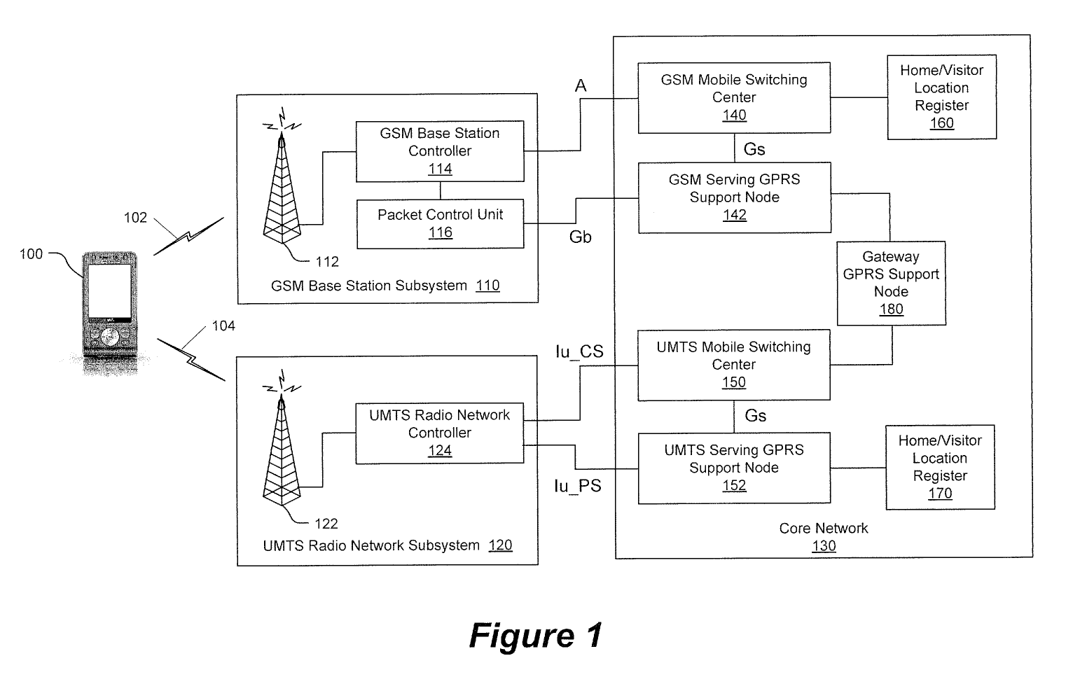

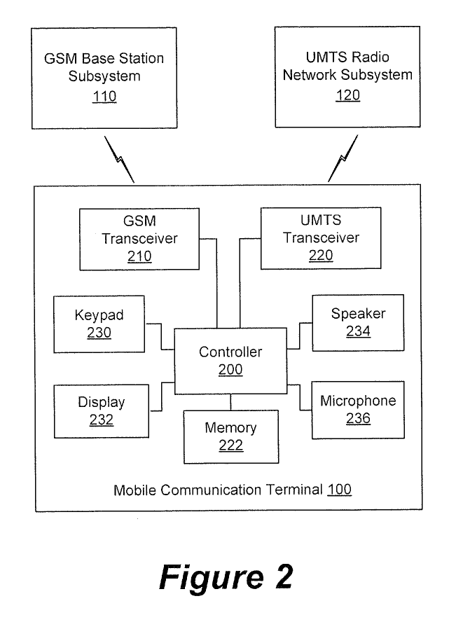

FIG. 1 illustrates a wireless communication system that, according to various embodiments of the present invention, is configured so that a mobile terminal can register with a UMTS network and then monitor for and respond to a paging request from a GSM network by setting up the corresponding call through the UMTS network. FIG. 2 illustrates an exemplary block diagram of circuitry of the wireless communication terminal shown in FIG. 1 in accordance with some embodiments of the present invention.

Referring to FIG. 1, the system includes a mobile terminal 100 and stationary communication components that can include a GSM base station subsystem 110, a UMTS radio network subsystem 120, and a core network 130.

The GSM base station subsystem 110 can include a GSM base transceiver station (BTS) 112, a GSM base station controller (BSC) 114, and a GSM packet control unit (PCU) 116. The GSM BSC 114 can be configured to carry out radio resource (e.g. time slot) allocation to the mobile terminal 100, frequency administration, and handover between GSM BTSs controlled by the GSM BSC 114. The GSM PCU 116 can be configured to manage packet communications, such as via a general packet radio service (GPRS), with the mobile terminal 100 through the GSM BTS 112.

The UMTS radio network subsystem 120 can include a UMTS Node B 122 and a UMTS radio network controller (RNC) 124. The UMTS RNC 124 can be configured to carry out radio resource allocation to the mobile terminal 100, frequency administration, and handover between nodes controlled by the UMTS RNC 124. The UMTS RNC 124 may include conventional serving RNC functionality, drift RNC functionality, and controlling RNC functionality. The UMTS RNC 124 can be configured to manage packet communications, such as via a general packet radio service (GPRS), with the mobile terminal 100 through the UMTS Node B.

For convenience of reference, the core network 130 has been illustrated as encompassing various components that are used to provide GSM and UMTS communication services to the mobile terminal 100. However it is to be understood that in practice some of these components can be arranged in different configurations and operated by different service provider entities. For example, a combined MSC and/or a combined SGSN may service traffic to both the GSM BSS 110 and the UMTS RNS 120.

The exemplary core network 130 may include a GSM mobile switching center (MSC) 140, a GSM serving GPRS support node (GGSN) 142, a UMTS mobile switching center (MSC) 150, a UMTS serving GPRS support node (SGSN) 152, and a gateway GPRS support node (GGSN) 180. Although separate components have been illustrated in the core network 130 for ease of explanation, it is to be understood that the functionality described herein for these components may be combined within less components or distributed differently among these or other components.

The GSM MSC 140 can set up and switch calls from/to the GSM BSC 114 (via an A interface) and a public switched telephone network (PSTN) and other networks. A home/visitor location register 160 can provide routing information for mobile terminated calls and SMS (Short Message Service), and may be responsible for the maintenance of user and visitor subscription information. The GSM SGSN 142 may be configured to track the location of the mobile terminal 100 and perform security functions and access control (e.g., to enable virtually always connected access to the mobile terminal 100). The GSM SGSN 142 interconnects the GSM PCU 116, via a Gb interface, to the GGSN 180 via a GPRS backbone IP network. The GGSN 180 routes packet data between the mobile terminal 100, via the GSM base station subsystem 110, and the Internet and/or other packet networks.

The UMTS MSC 150 can set up and switch calls from/to the UMTS RNC 124 (via a Iu_CS interface) and a public switched telephone network (PSTN) and other networks. A home/visitor location register 170 can provide routing information for mobile terminated calls and messaging, and may be responsible for the maintenance of user and visitor subscription information. The UMTS SGSN 152 may be configured to track the location of the mobile terminal 100 and perform security functions and access control (e.g., to enable virtually always connected access to the mobile terminal 100). The UMTS SGSN 152 interconnects the UMTS PCU and 26, via a Iu_PS interface, to the GGSM 180 via a GPRS backbone IP network. The GGSN 180 routes packet data, via the UMTS radio network subsystem 120, between the mobile terminal 100 and the Internet and/or other packet networks.

Referring now to FIG. 2, the mobile terminal 100 can include a controller 200, a GSM transceiver 210, a UMTS transceiver 220, a memory 222, and may further include a keypad 230, a display 232, a speaker 234, and a microphone 236.

The GSM transceiver 210 is configured to communicate according to a GSM protocol air interface 102 (FIG. 1), including predecessor and/or successor standards that define at least a portion of the GSM standard. The UMTS transceiver 220 is configured to communicate according to a UMTS protocol air interface 104 (FIG. 1), including predecessor and successor standards that define at least a portion of the UMTS standard. Air interface communication protocols as used herein may specify the information communicated, the timing of communication frames and/or time-slots, the frequency of control and traffic channels, the data modulation, and/or the operations for setting-up and/or maintaining communication from, to, and/or between two communication devices. As used herein, the term “communicate” means transmit, receive, and/or both transmit and receive.

The exemplary embodiments that are shown and described with regard to FIGS. 1-2 are provided for purposes of explanation of various embodiments, however it is to be understood that the present invention is not limited to such configurations, but is intended to encompass any configuration capable of carrying out at least one of the operational embodiments described herein.

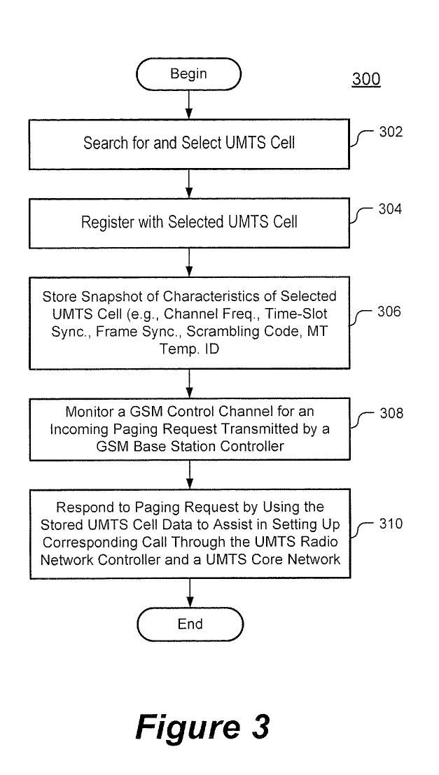

FIG. 3 illustrates a flowchart of operations 300 that may be carried out by the wireless communication terminal shown in FIGS. 1 and 2 and, more particularly, may be carried out by the controller 200 thereof, in accordance with some embodiments of the present invention. Referring to FIGS. 1-3, the controller 200 can be configured to search for and select (block 302) an available UMTS cell provided by the UMTS RNC 124. The controller 200 can then register (block 304) with the selected UMTS cell via the UMTS transceiver 220. The controller 200 can store UMTS cell data (block 306) that defines a snapshot of communication characteristics of the selected UMTS cell in the memory 222.

In some embodiments, the controller 200 may obtain and store (in the memory 222), as part of the UMTS cell data, frequency data for a control channel of the selected UMTS cell, synchronization data for a control channel of the selected UMTS cell, scrambling code for a communication channel of the selected UMTS cell, and/or a temporary identification code that has been assigned by the UMTS RNC 124 or a component of the core network 130 to the mobile terminal 100.

For example, the controller 200 may search for primary synchronization channels (P-SCHs) of a UMTS cell. In response to finding a P-SCH, the controller 200 may acquire synchronization data for it by correlating a received synchronization code word to known possible code words. The controller 200 may then acquire a primary scrambling code for the common pilot channel (CPICH) using the identified synchronization code word to identify a code group for the CPICH, and then testing codes in the identified code group until the primary scrambling code is identified as one that properly decoded received data. The controller 200 can then use the primary scrambling code to detect the common control physical channel (CCPCH) which carries system information that the controller 200 uses to determine whether it is a suitable UMTS cell for registration (e.g., access to it is allowed) and, if so, the controller 200 selects that UMTS cell.

The mobile terminal 100 responds to it having completing registration with the selected UMTS cell by now monitoring (block 308) a GSM control channel via the GSM transceiver 210 for an incoming paging request transmitted by the GSM BSC 114. The mobile terminal 100 responds to its receipt of a paging request (block 310) from the GSM BSC 114 by using the UMTS cell data, which was stored in the memory 222, to assist it in setting up a corresponding call via the UMTS transceiver 220 and selected UMTS cell through the UMTS RNC 124 and the core network 130.

Accordingly, by idling on a GSM control channel while waiting for a paging request, and then setting up the call through the UMTS RNC 124, the mobile terminal 100 may consume less power while idling and still enable use of more advanced performance and features provided by the UMTS RNC 124 during a call. Moreover, by storing the UMTS cell data in the memory 222 before idling on the GSM control channel, the mobile terminal 100 may be able to much more quickly setup the corresponding call through the selected UMTS cell.

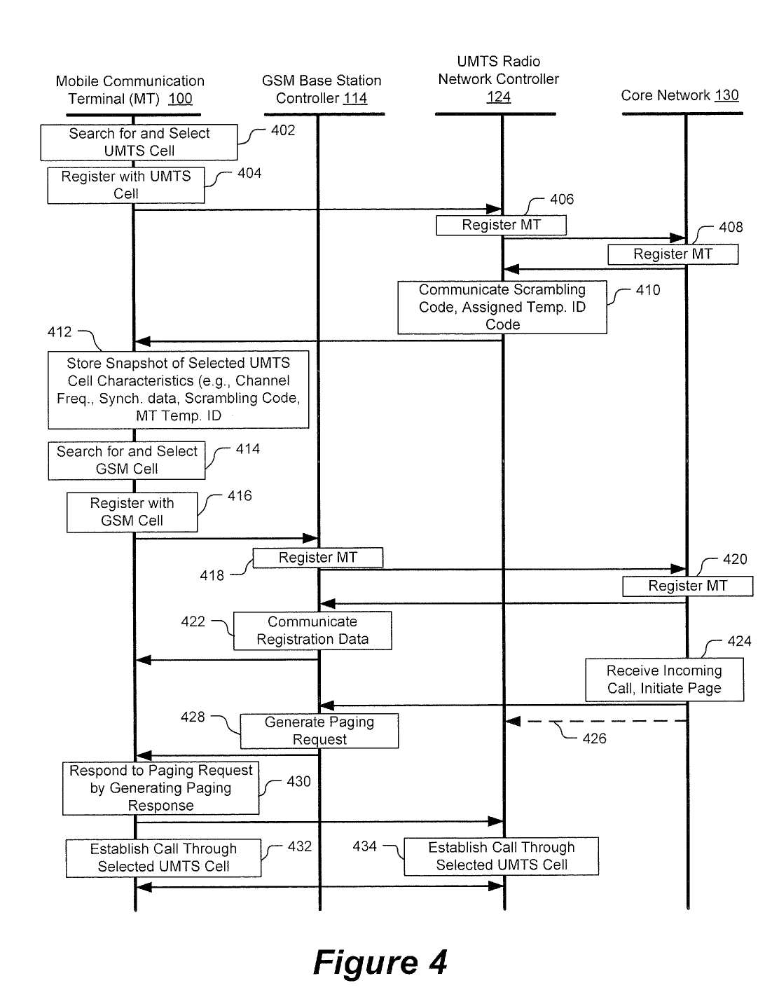

FIG. 4 illustrates a data flow diagram and flowchart of further operations that can be carried out by the mobile terminal 100 (e.g., by the controller 200) shown in FIGS. 1 and 2, by the GSM BSC 114, by the UMTS RNC 124, and by the core network 130 in accordance with some embodiments of the present invention. Referring to FIG. 4, the mobile terminal 100 searches for and selects (block 402) an available UMTS cell provided by the UMTS RNC 124. The mobile terminal 100 then transmits a registration request via the UMTS transceiver 220 to the UMTS radio network controller 124 to register (block 404) with the selected UMTS cell.

The UMTS RNC 124 may forward the registration request (block 406) to the core network 130 for authorization of service and registration of the mobile terminal (block 408). The core network 130 can transmit a registration response to the UMTS RNC 124. The UMTS RNC 124 may communicate (block 410) a scrambling code for a communication channel of the selected UMTS cell to the mobile terminal 100 and/or it may assign and communicate a temporary identification code to the mobile terminal 100.

The mobile terminal 100 may be configured to respond to a signal that indicates that its battery power source has less than a threshold remaining power reserve by at least temporarily ceasing monitoring of a control channel of the selected UMTS cell for an incoming paging request and by initiating monitoring of a GSM control channel for an incoming paging request transmitted by the GSM base station controller 114. Alternatively, mobile terminal 100 may respond to completion of registration with the selected UMTS cell by initiating monitoring of a GSM control channel for an incoming paging request transmitted by the GSM base station controller 114.

Before switching over to monitor GSM control channel for an incoming paging request, the mobile terminal 100 stores UMTS cell data (block 412) that defines a snapshot of communication characteristics of the selected UMTS cell. The mobile terminal 100 may be configured to obtain and store, as part of the UMTS cell data, the frequency data for a control channel of the selected UMTS cell, synchronization data for a control channel of the selected UMTS cell, the scrambling code for a communication channel of the selected UMTS cell, and/or the temporary identification code that has been assigned by the UMTS RNC 150 or a component of the core network 130 to the mobile terminal 100.

In some embodiments, the mobile terminal 100 may obtain and include synchronization data for a control channel of the selected UMTS cell as part of the stored UMTS cell data. The mobile terminal 100 may then respond to receipt of a paging request via the GSM transceiver 210 by controlling the UMTS transceiver 220 to synchronize its transmission of the call setup message to the control channel of the selected UMTS cell using the stored synchronization data.

In some embodiments, the mobile terminal 100 may obtain and include data that identifies a scrambling code for a communication channel of the selected UMTS cell as at least part of the stored UMTS cell data. The mobile terminal 100 may then respond to receipt of a paging request via the GSM transceiver 210 by transmitting a call setup message through the control channel of the selected UMTS cell using the stored scrambling code data to scramble the paging request when transmitted.

In some embodiments, the mobile terminal 100 may be configured to include the temporary identification code that is received through the UMTS transceiver 220 as at least part of the stored UMTS cell data. The mobile terminal 100 may then respond to receipt of a paging request via the GSM transceiver 210 by transmitting a call setup message, which includes the stored temporary identification code for the mobile terminal 100, to the UMTS RNC 124.

The mobile terminal 100 may power-down at least a portion of the UMTS transceiver 220 in response to completing registration with the selected UMTS cell to conserve power.

The mobile terminal 100 may search for and select a GSM cell (block 414) and transmit a registration request through the selected GSM cell (block 416). The GSM BSC 114 may forward the registration request (block 418) to the core network 130 for authorization of service and registration of the mobile terminal (block 420). The core network 130 can transmit a registration response to the GSM BSC 114. The GSM BSC 114 may respond by communicating (block 422) a control channel frequency and/or other registration data to the mobile terminal 100. The mobile terminal 100 then begins monitoring the identified control channel for an incoming paging request.

While the mobile terminal 100 is monitoring the GSM control channel for an incoming paging request, at least some of the stored UMTS cell data may become sufficiently outdated to no longer be appropriate for use to assist it with setting up a call with the UMTS RNC 124 and the core network 130.

Accordingly, in some embodiments, the mobile terminal 100 may respond to expiration of a threshold time after completing registration with the selected UMTS cell, during which no incoming paging request was received from the GSM base station controller, by obtaining and storing updated UMTS cell data and/or by obtaining and including updated synchronization data for the control channel of the selected UMTS cell as part of its storage of updated UMTS cell data. The mobile terminal 100 may respond to observing at least a threshold change in timing synchronization between the GSM transceiver 210 and the GSM BSC 114 by obtaining and storing updated UMTS cell data.

In some other embodiments, the mobile terminal 100 may respond to observing at least a threshold change in timing synchronization between the GSM transceiver and the GSM base station controller by obtaining and including updated synchronization data for the control channel of the selected UMTS cell as part of its storage of updated UMTS cell data.

In some other embodiments, the mobile terminal 100 may respond to initiation of a GSM cell reselection process by obtaining and storing updated UMTS cell data.

In some other embodiments, the mobile terminal 100 (via the controller 200) may respond to sensing a user triggered activity signal by obtaining and storing updated UMTS cell data. For example, the controller 200 may respond to sensing a portion of a housing for the mobile terminal 100 being opening, sensing actuation of a pressure switch of the mobile terminal 100, sensing a user touching a touch sensitive display 232 of the mobile terminal 100, and/or sensing movement of the mobile terminal 100 (e.g., via an accelerometer and/or a tilt sensor) by obtaining and storing updated UMTS cell data in preparation for the user initiating a call.

The controller 200 may be further configured to respond to sensing a portion of a housing for the mobile terminal 100 being opening, sensing actuation of a pressure switch of the mobile terminal 100, sensing a user touching the touch sensitive display 232 of the mobile terminal 100, and/or sensing movement of the mobile terminal by using the stored UMTS cell data to assist in monitoring a UMTS control channel of the selected UMTS cell in preparation for the user initiating a call.

The core network 130 receives an incoming call (block 424) and communicates a corresponding paging instruction to the GSM base station controller 114. The GSM BSC 114 responds by transmitting a paging request (block 428) to the mobile terminal 100 on the control channel. The GSM BSC 114 may further transmit (dashed data flow line 426) a paging request to the UMTS RNC 124 for transmission to the mobile terminal 100 in case mobile terminal 100 is monitoring a UMTS control channel instead of a GSM control channel.

The mobile terminal 100 responds to receipt of the pager request by powering-on any previously powered-down portion of the UMTS transceiver 220, and by generating a paging response which it transmits (block 430) to the UMTS RNC 124. The mobile terminal 100 and the UMTS RNC 124 may then carry out conventional UMTS call setup procedures (blocks 432 and 434).

In some embodiments, after the mobile terminal 100 carries out registration with the selected UMTS cell, the mobile terminal 100 may notify the UMTS cell that it will be monitoring a GSM control channel for an incoming paging request transmitted by a GSM base station controller. Accordingly, the core network 130 may they be configured to receive notification from the mobile terminal 100 through the UMTS RNC 124 that indicates that the mobile terminal 100 will monitor a GSM control channel from the GSM BSC 114 any incoming paging request. The core network 130 may then respond to the notification by forwarding a paging request (e.g. the paging request received in the block 424) to the GSM BSC 114 for transmission to the mobile terminal 100.

In the drawings and specification, there have been disclosed embodiments of the invention and, although specific terms are employed, they are used in a generic and descriptive sense only and not for purposes of limitation, the scope of the invention being set forth in the following claims.

What is claimed is:

1. A mobile terminal comprising:
a GSM transceiver that is configured to communicate via a GSM radio communication interface;
a UMTS transceiver that is configured to communicate via a UMTS radio communication interface; and
a controller that is configured to select and register with a UMTS cell provided by a UMTS radio network controller, to store UMTS cell data defining a snapshot of communication characteristics of the selected UMTS cell, to respond to having registered with the selected UMTS cell by monitoring a GSM control channel via the GSM transceiver for an incoming paging request transmitted by a GSM base station controller, and to respond to receipt of the paging request from the GSM base station controller by using the stored UMTS cell data to assist in setting up a corresponding call via the UMTS transceiver and the selected UMTS cell through the UMTS radio network controller and a UMTS core network.

2. The mobile terminal of claim 1, wherein:
the controller is further configured to respond to completing registration with the selected UMTS cell by selecting and registering with a GSM cell provided by a GSM base station controller, and monitoring the GSM control channel of the GSM base station controller for the paging request.

3. The mobile terminal of claim 1, wherein:
the controller is further configured to respond to a signal indicating that a battery power source of the mobile terminal has less than a threshold remaining power reserve by at least temporarily ceasing monitoring of a control channel of the selected UMTS cell for a paging request transmitted by the UMTS radio network controller and by initiating monitoring of the GSM control channel via the GSM transceiver for the paging request transmitted by the GSM base station controller.

4. The mobile terminal of claim 1, wherein:
the controller is further configured to include frequency data for a control channel of the selected UMTS cell as at least part of the stored UMTS cell data, and to respond to receipt of the paging request from the GSM base station controller by controlling the UMTS transceiver to transmit a call setup message at the control channel frequency that is defined by the stored frequency data.

5. The mobile terminal of claim 4, wherein:
the controller is configured to obtain and further include synchronization data for a control channel of the selected UMTS cell as part of the stored UMTS cell data, and to respond to receipt of the paging request from the GSM base station controller by controlling the UMTS transceiver to synchronize its transmission of the call setup message to the control channel of the selected UMTS cell using the stored synchronization data.

6. The mobile terminal of claim 1, wherein:
the controller is further configured to obtain and include data that identifies a scrambling code for a communication channel of the selected UMTS cell as at least part of the stored UMTS cell data, and to respond to receipt of the paging request from the GSM base station controller by transmitting a call setup message through the control channel of the selected UMTS cell using the stored scrambling code data to scramble the paging request when transmitted.

7. The mobile terminal of claim 1, wherein:
the controller is further configured to receive via the UMTS transceiver a temporary identification code that has been assigned by the UMTS core network to the mobile terminal, to include the temporary identification code as at least part of the stored UMTS cell data, and to respond to receipt of the paging request from the GSM base station controller by transmitting a call setup message, which includes the stored temporary identification code for the mobile terminal, to the UMTS radio network controller.

8. The mobile terminal of claim 1, wherein:
the controller is further configured to include frequency data for a control channel of the selected UMTS cell as at least part of the stored UMTS cell data, and to respond to receipt of the paging request from the GSM base station controller by controlling the UMTS transceiver to transmit a call setup message at the control channel frequency that is defined by the stored frequency data;
the controller is configured to further include synchronization data for a control channel of the selected UMTS cell as part of the stored UMTS cell data, and to respond to receipt of the paging request from the GSM base station controller by controlling the UMTS transceiver to synchronize its transmission of the call setup message to the control channel of the selected UMTS cell using the stored synchronization data;
the controller is further configured to include data that identifies a scrambling code for a control channel of the selected UMTS cell as at least part of the stored UMTS cell data, and to respond to receipt of the paging request from the GSM base station controller by transmitting a call setup message through the control channel of the selected UMTS cell using the stored scrambling code data to scramble the paging request when transmitted; and
the controller is further configured to receive via the UMTS transceiver a temporary identification code that has been assigned by the UMTS core network to the mobile terminal, to include the temporary identification code as at least part of the stored UMTS cell data, and to respond to receipt of the paging request from the GSM base station controller by transmitting a call setup message, which includes the stored temporary identification code for the mobile terminal, to the UMTS radio network controller.

9. The mobile terminal of claim 1, wherein:
the controller is further configured to power-down at least a portion of the UMTS transceiver in response to completing registration with the selected UMTS cell, and to power-on the previously powered-down portion of the UMTS transceiver in response to receiving the paging request from the GSM base station controller.

10. The mobile terminal of claim 1, wherein:
the controller is further configured to respond to expiration of a threshold time after completing registration with the selected UMTS cell during which no paging request was received from the GSM base station controller by obtaining and storing updated UMTS cell data.

11. The mobile terminal of claim 10, wherein:
the controller is further configured to respond to expiration of the threshold time after completing registration with the selected UMTS cell during which no paging request was received from the GSM base station controller by obtaining and including updated synchronization data for the control channel of the selected UMTS cell as part of its storage of updated UMTS cell data.

12. The mobile terminal of claim 1, wherein:
the controller is further configured to respond to observing at least a threshold change in timing synchronization between the GSM transceiver and the GSM base station controller by obtaining and storing updated UMTS cell data.

13. The mobile terminal of claim 12, wherein:
the controller is further configured to respond to observing at least a threshold change in timing synchronization between the GSM transceiver and the GSM base station controller by obtaining and including updated synchronization data for the control channel of the selected UMTS cell as part of its storage of updated UMTS cell data.

14. The mobile terminal of claim 1, wherein:
the controller is further configured to respond to initiation of a GSM cell reselection process by obtaining and storing updated UMTS cell data.

15. The mobile terminal of claim 1, wherein:
the controller is further configured to respond to sensing a user triggered activity signal by obtaining and storing updated UMTS cell data.

16. The mobile terminal of claim 15, wherein:
the controller is further configured to respond to sensing a portion of a housing for the mobile terminal being opening, sensing actuation of a pressure switch of the mobile terminal, sensing a user touching a touch sensitive display of the mobile terminal, and/or sensing movement of the mobile terminal by obtaining and storing updated UMTS cell data in preparation for the user initiating a call.

17. The mobile terminal of claim 1, wherein:
the controller is further configured to respond to sensing a portion of a housing for the mobile terminal being opening, sensing actuation of a pressure switch of the mobile terminal, sensing a user touching a touch sensitive display of the mobile terminal, and/or sensing movement of the mobile terminal by using the stored UMTS cell data to assist in monitoring a UMTS control channel of the selected UMTS cell in preparation for the user initiating a call.

18. The mobile terminal of claim 1, wherein:
the controller is further configured to respond to completing registration with the selected UMTS cell by notifying the UMTS core network via the UMTS transceiver that it will monitor a GSM control channel for a paging request from a GSM base station controller.

19. A method comprising:
receiving notification at a core network through a UMTS radio network controller from a mobile terminal that indicates that the mobile terminal will monitor a GSM control channel from a GSM base station controller for any paging request;
responding to the notification by forwarding a paging request, which is received by the core network and is directed to the mobile terminal, to the GSM base station controller for communication to the mobile terminal;
receiving a paging response from the mobile terminal through the UMTS radio network controller; and
establishing a call with the mobile terminal, responsive to the paging response, through the core network and the UMTS radio network controller.

20. A core network comprising:
a UMTS mobile switching center that is configured to receive notification from a mobile terminal through a UMTS radio network controller that indicates that the mobile terminal will monitor a GSM control channel from a GSM base station controller for any paging request, and to respond to the notification by forwarding a paging request, which is directed to the mobile terminal, to the GSM base station controller for communication to the mobile terminal, and to respond to receipt of a paging response from the mobile terminal through the UMTS radio network controller by establishing a call with the mobile terminal through the UMTS radio network controller.
